(19) United States
(12) Patent Application Publication
(10) Pub. No.: US 2010/0151342 A1
(43) Pub. Date: Jun. 17, 2010

(54) TUBULAR FUEL CELL DESIGN WITH IMPROVED CONSTRUCTION AND OPERATING EFFICIENCY

(75) Inventor: Gregory A Campbell, Canton, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Castle Research Associates inc, Canton, NY (US)

(21) Appl. No.: 12/527,939

(22) PCT Filed: Feb. 20, 2008
(86) PCT No.: PCT/US08/54385

§ 371 Date: Jan. 7, 2010

Related U.S. Application Data
(60) Provisional application No. 60/902,312, filed on Feb. 20, 2007.

(51) Int. Cl. H01M 8/10; H01M 4/64; H01M 8/04

(52) U.S. Cl. 429/442; 429/517; 429/480

(57) ABSTRACT

In this improved tubular fuel cell design the anode and cathode current collectors also may perform as the gas diffusion members at the respective anode and cathode as well as external electrical contacts for current flow in the external circuit. The fuel cell has a sealing system that is designed to effectively keep the anode and cathode gases on their perspective sides of the proton exchange membrane separating the cathode and anode. The fuel cell has a hollow gas chamber designed to have very small pressure drops. The construction of the hollow anode gas chamber reduces pressure drop of the hydrogen, thus increasing overall reaction rate. The hollow cathode gas chamber may be designed with decreasing cross section from inlet to outlet in order to reduce the pressure drop in the chamber and thus optimize the reaction rate at the cathode.

### CROSS REFERENCE TO RELATED APPLICATIONS

This patent application claims the benefit of U.S. Pat. App. Ser. No. 60/902,312, filed Feb. 20, 2007, the entirety of each application is incorporated by reference herein.

### FIELD OF THE INVENTION

This invention relates to improved high power to weight ratio, low temperature, proton exchange membrane, tubular fuel cells and methods for constructing said tubular fuel cells.

### BACKGROUND OF THE INVENTION

The potential use of fuel cells in many applications such as home power supplies, electronic device power, automotive power systems, wearable military power packs, and industrial electric and heat sources has dominated the news recently. Tubular fuel cells offer a potential power per weight advantages and design simplification relative to conventional carbon plate stacked proton exchange membrane devices.

There are several limitations with the current flat and cylindrical designs. A cylindrical fuel cell is described in U.S. Pat. No. 6,001,500. In this disclosure all of the membrane assemblies had a gas diffusion electrode in addition to a current collector, adding to the cost and complexity of the device. Also, to quote the authors of the patent, “The rolled sheet prototypes (1-4 and 11) suffered from insufficient interface contact between layers.” The structure in this cylindrical fuel cell would lead to water condensing and inhibiting the flow. Also, external humidification needed to be provided.

Patent application US 2005/0196656 describes a device with Hydrogen flowing through the device, FIG. 2 in US 2005/0196656, which leads to parasitic power losses due to the need of repressurizing Hydrogen before it is directed to the inlet or to loss of the expensive Hydrogen gas if it is vented to the atmosphere. Also, it is well known fact that the rate of the cathode reaction is 100 to 200 time slower than the anode reaction. This would minimize the effect of raising the anode pressure which will have little or no effect, since the rate limiting process occurs on the cathode.

The devices described in U.S. Pat. Nos. 6,063,517 and 6,007,932, are similar to the devices described in paragraphs 0003 and 0004 in that the flow paths for both the anode and the cathode are long and narrow channels in the bipolar plates thus leading to high pressure drop as the reactants flow through the cells. This reduces the average reactant concentration and thus the reaction rates at both the anode and cathode regardless of the inlet pressure. Furthermore, these long narrow channels lead to water condensation into droplets in the channel that are large enough to essentially fill the channel and thus block the flow of gas, The pressure necessary to push the water droplet through the channel forces the liquid water into the reaction layer of the membrane assembly leading to degradation of the carbon support and thus the power as a function of cyclic startups. These traditional fuel cells are constructed with membrane electrode assemblies (MEA). These MEA structures are usually five layer consisting of a core membrane that is permeable to protons and water but essentially impermeable to the reaction gases, reaction anode and cathode layers and gas diffusion layers on each side of the structure. The MEA is sandwiched between bipolar plates that act as current collectors. These bipolar plates also have narrow gas flow channels. There is also an external cathode and anode attached to the sides of the bipolar plates on the cathode and anode external sides of the bipolar plates that transfer the current from the cell or stack to the working device. Each of these components adds to the cell resistance in a series manner and thus reduces the potential power production of the cell.

In U.S. Pat. No. 6,376,116 B1 an effort is made to mitigate the pressure loss problem on the air, oxygen side of the fuel cell, the inventors use free convection on the cathode side. Since the reaction is cathode rate limited, this limits the power that can be realized by this design. In order to humidify the gas most of the known literature describes the hydrogen gas continuously flowing through the anode and it must be recompressed or vented to the atmosphere.

U.S. Pat. No. 6,972,160 B2 describes a device that is restricted to incorporating carbon fibers into the electrode for a methanol fuel cell device.

U.S. Pat. No. 6,352,742 B1 restricts the membrane to a rotating cylinder formed membrane.

### SUMMARY OF THE INVENTION

This invention provides both methods and systems for efficiently producing electrical power from tubular fuel cell systems. The systems consist of:

A source of fuel that will produce protons and electrons;

Integrated, liquid water shedding, essentially constant fuel pressure containment tubular structure;

source of oxidizer that will utilize the produced protons and electrons;

A combined load electrode, gas diffuser and anode current collector;

An anode electrode;

A proton conductive membrane;

A cathode electrode;

A combined load electrode, gas diffuser and cathode current source;

Integrated, liquid water shedding, essentially constant fuel pressure containment tubular structure;

And integrated humidity, temperature, and gas flow/pressure control.

### BRIEF DESCRIPTION OF THE DRAWINGS

FIG. 1 Typical Flat Membrane Fuel Cell

FIG. 2 Single Cell Tubular Fuel Cell

FIG. 3 Details of Gas Diffuser/Electron Collectors, External Electrode and Membrane Electrode Assembly (element 100)

FIG. 4 Details of Fuel Cell Stack Using Tubular Construction

FIG. 5A-5D show Typical Tubular Fuel Cell Geometric Arrangements

FIG. 6 Details of Fuel Cell Reactant Internal Humidity Control with Temperature Control

### DESCRIPTION OF THE PREFERRED EMBODIMENT

In a preferred embodiment of this invention, there would be a substantially reduced production cost due to fewer and less expensive components. The light weight construction will lead to overall better power density as a function of cell weight. Furthermore, the operational costs would be lower because of the reduced need to pressurize the reactant gases and the integrated humidification control of the gases. Because there is a higher exposed area of the membrane due to the removal of the gas flow channels, these tubular fuel cells will produce more current for a specific membrane size and quality than conventional fuel cells previously invented.

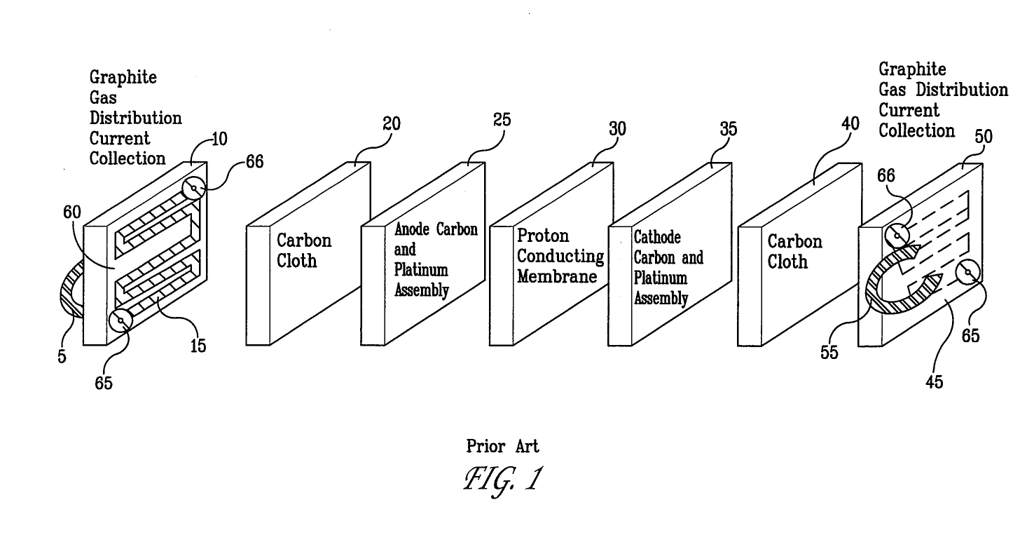

In order to fully appreciate the inventions in the preferred embodiment of this tubular fuel cell, a diagram of a conventional flat panel fuel cell is found in FIG. 1. Elements 5 through 66 in FIG. 1 are elements of a typical conventional fuel cell. The typical membrane electrode assembly is made up of elements 20 through 40. The carbon open structure cloths, 20 and 40, are required because the gas in channel structure 15 and 50 is restricted from as much as 50% of the catalyst containing areas 25 and 35. This is due to the solid channel component, 60, width necessary to collect and deliver the electrons produced at 25, the anode electrode and used at 35, the cathode electrode. Also, as the gas flows from the inlet 65 to the outlet 66 of channels 15 and similarly in channel 50, the pressure is reduced substantially because of the flow resistance in the relative small narrow cross section channels thus reducing the concentration of the hydrogen and oxygen in a typical hydrogen-oxygen proton electrode membrane fuel cell. Finally, water often condenses in the narrow channels 15 and 50, further reducing the flow of the reactant gases. This leads to a reduced reaction rate. The external separate electrodes 5 and 55 provide the electron source and sink needed to power the external circuit associated with the use of the fuel cell. The preferred embodiment of the tubular fuel cell described below minimizes many of these difficulties.

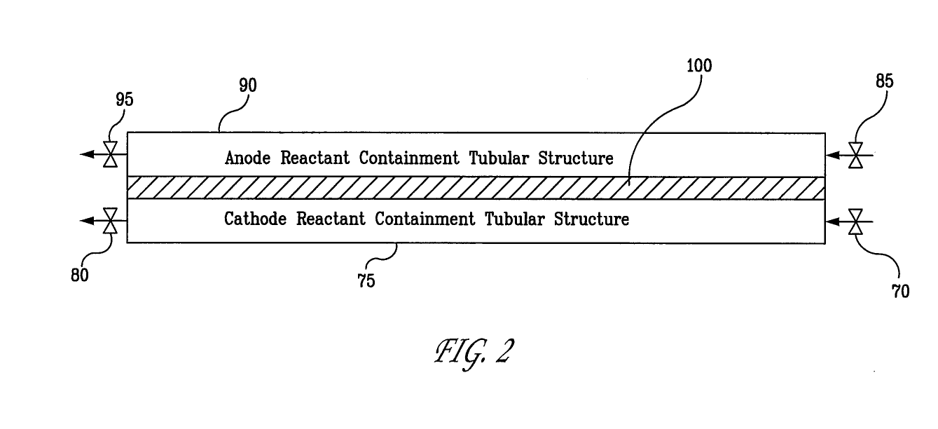

A center line cross-sectional view of the overall design of this simplified tubular fuel cell is found in FIG. 2. The fuel cell is constructed with cathode reactant flow control using inlet 70 connected to the cathode reactant tubular structure 75, an integrated, liquid water shedding, essentially constant fuel pressure containment tubular structure, which is connected to the exit flow control 80. Similar elements 85, cathode reactant tubular structure 90, acting as an integrated, liquid water shedding, essentially constant fuel pressure containment tubular structure, and 95 constitute the anode reactant tubular structure flow control. The active element in this fuel cell is element 100 which acts as the external anode and cathode, current collector, gas disperser, cathode and anode electrodes, and proton diffusion membrane. The membrane must be essentially non-permeable to both anode and cathode reactants while effectively allowing diffusion of protons. If it is desired to run the fuel cell in a dead headed manner element 80 and 95 are controlled to allow no external flow of the reactants; all reactants flowing through 70 or 85 would be consumed in element 100. The preferred embodiment would have containment tubular structures of any geometry that would provide essentially no pressure drop while having the reactants in intimate proximity of element 100.

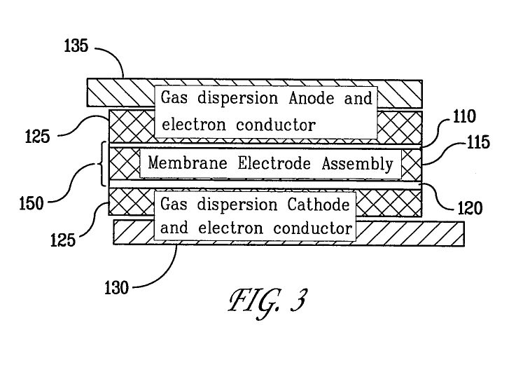

FIG. 3 describes, using a center line view of the fuel cell element 100 typical details of assembly. At the center of the assembly is a 3 layer membrane electrode assembly, MEA, element 105. Element 105 is constructed using the following: element 110, the anode electrode which is a composite of a catalyst, often platinum metal, typically in our studies about 0.4 milligrams per square centimeter of anode surface area, supported on carbon black. These composite particles are bound together with a proton conducting polymer, in many cases NAFION, a DuPont patented polymer. This provides a so-called triple interface where the reactant can have access to the catalyst and the associated proton produced will have a diffusion path through the anode electrode to element 115, the proton diffusion membrane. The membrane must essentially stop permeation of the reactants to the cathode electrode element 120 the third element of the MEA. The membrane is typically a film of NAFION about 75 microns thick. Element 120 is often produced in the exact same manner as element 110. A common difference is that the catalyst loading on element 120 may be somewhat higher than on element 110 because the oxidation reaction on the cathode can be much slower that the reaction on the anode. Element 125 is a gas diffuser, electron collector on the anode and an electron disperser on the cathode. This is typically a screen, any good conductor would be effective and a partial list of possible materials are platinum, copper, stainless steel, gold, or silver. It is desirable to have very good oxidation resistance on the cathode side for long term use. For short term system evaluation, any good conductor will work. We have used platinum and copper in our research extensively. The screen can be placed directly onto the anode or cathode 110 and 120. The screen provides essentially a point contact and thus does not essentially impede gas diffusion to the reaction layer as observed with element 60 in the conventional flat fuel cell. At times a porous carbon cloth is attached to the screen to minimize the tendency of the screen, if it has a high modulus, to penetrate the MEA. Element 125 is attached, often soldered, to element 130 on the cathode side and element 135 on the anode side of the fuel cell. Because of this intimate metal molecular contact and the point contact of element 125 with the MEA, the diffusion and electrical internal cell resistance is substantially reduced leading to better performance at high current flow conditions than the serpentine channels with relatively wide contact area found in conventional bipolar plates. The screens, element 125 in conjunction with the elements 75 and 90 have been found to inhibit the formation of liquid water structure that would reduce the reactant availability to the anode, element 110, and cathode, 120. Usually serpentine flow channels are used in commercial hi-performance PEMFC irrespective of their orientation, it is not possible to utilize the gravitational force for removal of liquid water from the flow channels in such configurations. However, in the tubular configuration, as the water droplets emerge at the screen-gas diffusion layer interface, gradational forces can be utilized to over come the surface tension force. The water droplets are thus conveyed to the reservoir-humidifier. Elements 130 and 135 may also provide a sealing surface for both the MEA and the anode and cathode reactant tubular structures.

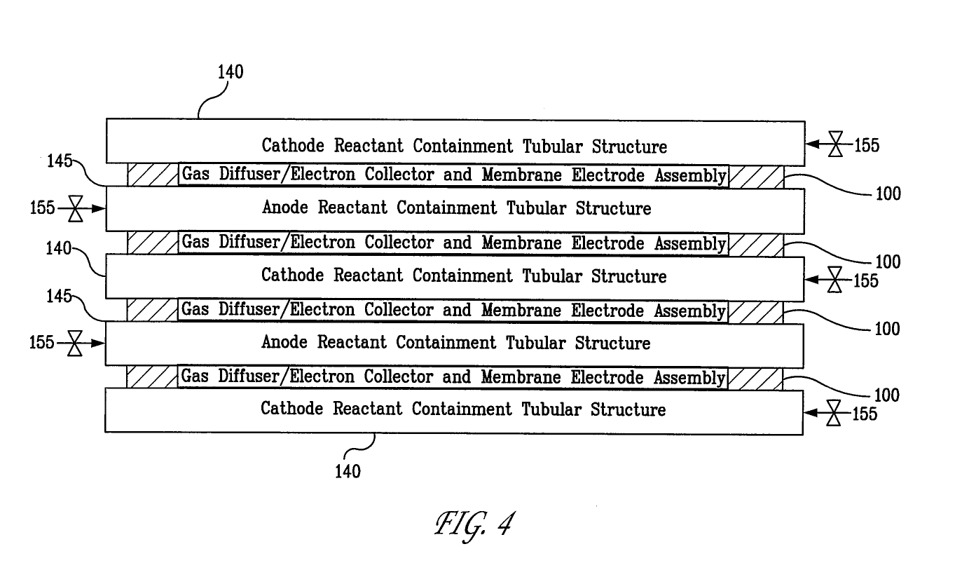

Details of a tubular fuel cell stack are found in FIG. 4. Single hydrogen based fuel cells typically have a open circuit voltage of 0.95 volts. Tt acceptable current production, the voltage for a single cell is nominally 0.5 to 0.6 volts. It would thus take three of these cells in series to produce the voltage of a dry cell battery, 1.5 volts, and about 7 cells in series to produce the voltage necessary to charge a lithium ion battery, about 3.7 volts. In order to get these higher necessary voltages, the single fuel cell elements are arranged into stacks. Referring to FIG. 4 elements 140 and 145 are the cathode tubular structures and the anode tubular structures. Elements 155 are the control systems used for the cathode reactant, air or oxygen, and the anode reactant, either hydrogen or methanol. For our development work, we used flow control valves attached to a two stage regulator on hydrogen or oxygen tanks The flow was measured using a mass flow meter. Element 100 is an assembly constituting elements 105 through 135. It can be observed that on the internal elements of the stack the Anode or Cathode Reactant Containment Tubular Structure delivers reactant to two reaction surfaces. The external connections of elements 130 and 135 would be attached in series such that the voltage in this stack would be 4 time the voltage from a single cell operated under the same conditions.

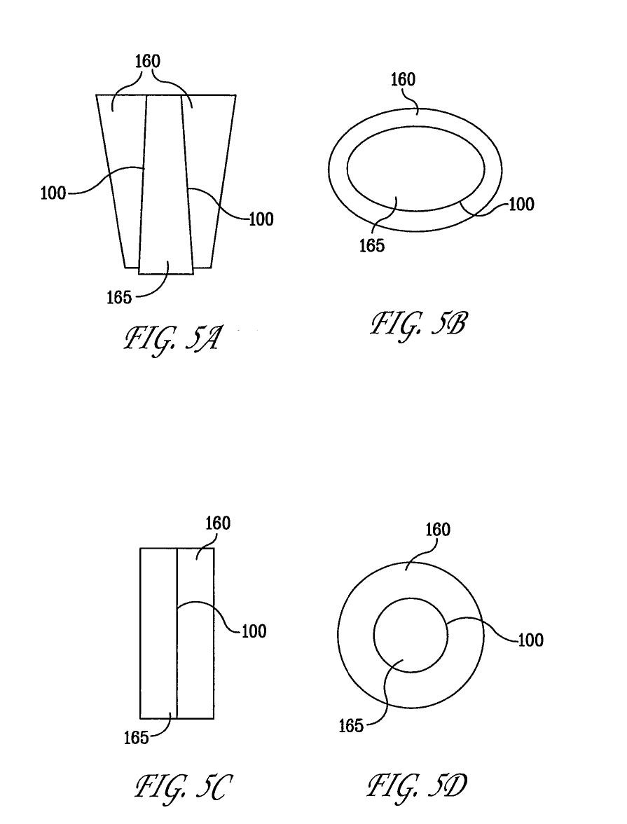

This tubular fuel cell design lends itself to many configurations. The only constraints are that the Reactant Containment Tubular Structure, 75 and 90 in the single cell design, or 140 and 145 in the stack design discussed above not promote liquid water structures that tend to reduce cell efficiency. This essentially requires that the design not have narrow channels for the gas to flow as it moves through the cell. Second, the cell design incorporate an element that acts as the gas diffusion medium, and has essentially point contact with the reaction electrode to reduce reactant and product diffusion to and from the electrodes, has point contact for electron transfer to and from the reaction electrodes, and acts as the external electrode for the cell. Cells with the geometries found in FIG. 5A-5D have been made. FIG. 5A shows a truncated cone; FIG. 5B made an elliptical structure; FIG. 5C made a rectangular structure; and FIG. 5 shows a cylindrical structure. These embodiments fit the two criteria. In all cases the anode in element 100 contacts tubular structure 160, and the cathode in element 100 contacts tubular structure 165.

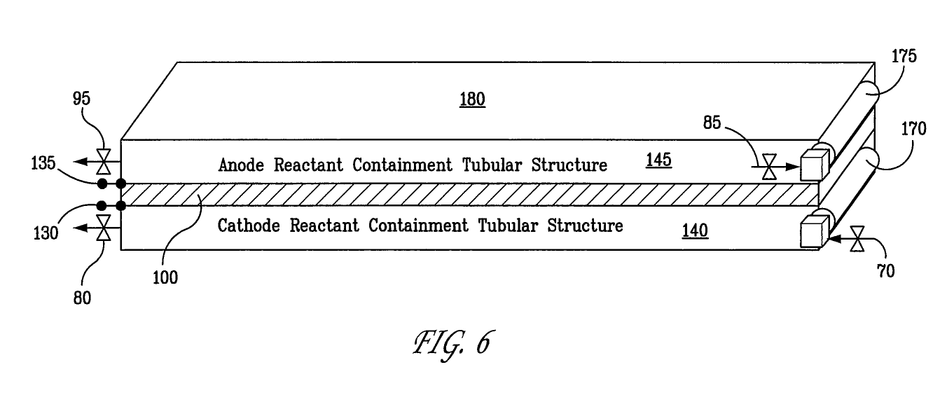

It is important to control the internal humidity and temperature of fuel cells to obtain maximum output and cell voltage and current stability. A fuel cell was constructed using two concentric tubular containment structures elements 140, a 65 cc syringe, and 145. a 10 cc syringe in the unwrapped view depicted in FIG. 6. Element 145 was perforated with hundreds of small holes. A copper screen with an open area of about 40 percent, was wrapped around the syringe after having a copper wire soldered to the screen. The MEA element 105 was then wrapped around the screen and sealed to the syringe with electrical tape. A second screen with soldered wire external electrode was wrapped over the MEA and bound with several copper wire circles twisted tightly on the wire. This structure was then suspended in a 65 cc syringe which acted as the second tubular containment structure. Element 100 was connected to an external load through external electrodes 130 and 135. Hydrogen was the anode reactant and oxygen was the cathode reactant. Water filled internal passive humidification devices 170 and 175 were incorporated in the design such that the water was heated to essentially the same temperature as the cell. Hydrogen and oxygen gases were then flowed to the anode and cathode respectively after filling the humidification cavity with water and directing the flow through this chamber. The gas rate from the cylinder was controlled by 70 and directed through 170 was humidified before it entered element 140. The gas from the hydrogen cylinder was rate controlled using element 85 and directed through element 175 thus being humidified before it entered 145.

The temperature of the fuel cell FIG. 6, was controlled by using a hot air source blowing air onto surface 180 of the anode containment vessel 145. This provides a proper heat transfer to allow the internal temperature of the fuel cell to remain essentially constant at about 60° C. as measured using a thermocouple located at the anode current collector 125 connected internally to the anode electrode 135. The anode and cathode gas flow were controlled by valves and the flow rates controlled by Rota meters on each reactant, elements 70 and 85. The internal pressure of the Reactant Containment Tubular Structures elements 140 and 145 were controlled by restrictor valves, in this case stoppers from the syringe, elements 80 and 95 respectively.

### Example 1

An example of the tubular fuel cell was constructed as follows. Two platinum alloy arterial stints, essentially screens, were used as the gas dispersers and current collectors and catalysts and external electrodes. An annular NAFION membrane was constructed and one of the stints was expanded into the annulus of the membrane. The other stint was compressed on the outside of the membrane. The stints provide a structure with up to 80% open area. The stints acted as gas diffusers, current collectors, external electrodes, as well as catalysts. They thus were the source of catalytic activity. Hydrogen gas was flowed through the annular stint and air across the external stint. A voltage of 0.5 volts was measured while the hydrogen flowed. When the hydrogen flow was reduced to 0.0, the voltage went to 0.0.

### Example 2

The tubular fuel cell in Example 1 was then duplicated for use with a liquid fuel. Two platinum alloy arterial stints were used as the gas dispersers and current collectors. A NAFION membrane was constructed and one of the stints was expanded into the annulus of the membrane. The other stint was compressed on the outside of the membrane. The stints acted as both gas diffusers and current collectors. They also were the source of catalytic activity. Ethanol liquid was placed in the annular stint and air flowed across the external stint. A voltage of 0.43 volts was measured.

### Example 3

A 10 cc syringe was drilled with small holes so that the hole pattern on the surface was about the same size as the 10 sq. cm. active surface area of the MEA. This left enough material to provide the strength to construct the tubular fuel cell. A copper wire screen with a copper wire attached with solder, the gas disperser and electron collector and external electrode was wrapped around the syringe; a commercial membrane electrode assembly was then wrapped around the copper wire screen and electrical tape used to seal the edges of the system so that the hydrogen that would flow inside of the syringe would not escape from the syringe containment tubular structure. A second copper wire screen, cathode gas disperser and electron conductor and external electrode, was wrapped around the membrane electrode assembly. Hydrogen was introduced into the syringe and the two screens were connected to a voltage and current measuring device. A voltage of 0.54 volts and a current of 0.64 amperes were recorded.

### Example 4

The same procedure was used to produce the fuel cell as in Example 3 except the external screen was attached more securely by 4 loop of wire wound tightly around the external in a cylindrical direction. The voltage and current were recorded at different loads and the results compared for the same commercial membrane using a commercial laboratory bipolar plate flat current collector fuel cell obtained from the Fuel Cell Store. In order to check the effect of liquid water on the tubular fuel cell, liquid water was sprayed directly on the cathode and anode tubular surfaces of the fuel cell. No degradation in performance was observed as a result of this liquid water being sprayed into the channel and onto the current collector. To our surprise the tubular fuel cell with its fewer components had much better output characteristics than the traditional flat, planar, fuel cell. The lower rate of degradation in performance can be to a great part due to the much better liquid water handling characteristics of the open tubular structure which does not allow the liquid to block the tubular channel thus the water flows harmlessly into a water reservoir. Comparative results are found below:

Performance of the conventional planar cell:

| | |
|---|---|
| | 20 start-ups & 25 hrs of |
| 1^{ST} DAY (anode fuel | operation (anode fuel |
| externally humidified) | externally humidified) |

| | Current | | Current |
|---|---|---|---|
| | density | | density |
| Voltage | (mA/cm2) | Voltage | (mA/cm2) |
| 0.65 | 44.7 | 0.5 | 22.1 |
| 0.73 | 23.3 | 0.56 | 10.8 |
| 0.78 | 14.7 | 0.62 | 4.3 |
| 0.83 | 7.8 | 0.65 | 6.7 |
| 0.91 | 1 | 0.7 | 1.2 |
| 0.93 | 0.8 | 0.72 | 0.5 |
| 0.94 | 0.4 | 0.74 | 0.2 |
| 0.97 | 0 | 0.75 | 0 |

Performance of the cylindrical cell:

| | | 13 start-ups | | 14 start-ups | | 16 start-ups | |
|---|---|---|---|---|---|---|---|
| | | & 14 hrs of | | and 15 hrs of | | and 17 hrs | |
| 1^{st} day (anode | | operation (anode | | operation (anode | | of operation | |
| fuel humidified | | fuel humidified | | fuel humidified | | (anode fuel | |
| in-situ) | | in-situ) | | in-situ) | | humidified in-situ) | |
| | Current | | Current | | Current | | Current |
| | density | | density | | density | | density |
| Voltage | (mA/cm2) | Voltage | (mA/cm2) | Voltage | (mA/cm2) | Voltage | (mA/cm2) |
| 0.55 | 160.6 | 0.53 | 157.5 | 0.53 | 156.2 | 0.54 | 157.5 |
| 0.73 | 43 | 0.72 | 42.5 | 0.73 | 37.9 | 0.73 | 41.9 |
| 0.79 | 20 | 0.78 | 18.5 | 0.78 | 17.1 | 0.78 | 21.1 |
| 0.81 | 12 | 0.79 | 12.5 | 0.79 | 13.8 | 0.8 | 13.8 |
| 0.82 | 8 | 0.82 | 7.3 | 0.81 | 7.9 | 0.82 | 8 |
| 0.87 | 1.6 | 0.86 | 1.7 | 0.86 | 1.6 | 0.87 | 1.6 |
| 0.87 | 0.8 | 0.87 | 0.8 | 0.87 | 0.8 | 0.87 | 0.8 |
| 0.88 | 0.4 | 0.87 | 0.4 | 0.87 | 0.4 | 0.88 | 0.4 |
| 0.88 | 0 | 0.87 | 0 | 0.87 | 0 | 0.88 | 0 |

### Example 5

A new fuel cell was constructed in a similar manner as in Examples 3 and 4 except the syringe was drilled to a greater extent in order to give the hydrogen gas more direct access to the anode screen. The current and voltage improved. This cell was cycled on and of for over 50 cycles and with a total on time of over 90 hours and the voltage and current only decrease by 5%. Results recorded below:

Fuel Cell Repeated on Cyclic Response

| | |
|---|---|
| | 50 start-ups & 90 hrs |
| | of operation |
| Initial 0 hrs of | (anode fuel |
| operation | humidified in-situ, |
| (anode fuel | anode side blocked- |
| humidified in-situ) | out) |

| | Current | | Current |
|---|---|---|---|
| | density | | density |
| Voltage | (mA/cm2) | Voltage | (mA/cm2) |
| 0.5 | 166.4 | 0.55 | 165.5 |
| 0.71 | 45.5 | 0.72 | 48.2 |
| 0.78 | 20.3 | 0.78 | 23.8 |
| 0.8 | 13.3 | 0.8 | 14.5 |
| 0.82 | 8 | 0.83 | 7.4 |
| 0.86 | 1.7 | 0.87 | 1.7 |
| 0.87 | 0.8 | 0.87 | 0.8 |
| 0.87 | 0.4 | 0.88 | 0.6 |
| 0.88 | 0 | 0.88 | 0 |

### Example 6

After 50 cycles the fuel cell in Example 5 was modified. In this case a 60 cc syringe was modified and was used to enclose the fuel cell previously used in Example 5 as the cathode tubular containment structure. It was fitted such a hydrogen inlet tube having an inline hydrogen humidifier. This hydrogen tube after leaving the humidifier penetrated the 60 cc syringe and was connected to the 10 cc syringe which acts a the hydrogen tubular containment structure. During the operation the hydrogen flow control was used to stop flow from the hydrogen tubular containment structure into the environment. Thus the only hydrogen flow was due to the chemical reaction on the anode catalyst. The current and voltage response were measured. The voltage and current density were recorded while the cell was temperature controlled at using a thermocouple at the anode side of the MEA and a heat air gun to provide heat thus keeping the cell at about 65° C.=1-3° C. Results recorded below:

Tubular temperature controlled Structure, with internal passive
humidification devices, repeat start up performance

27 membrane start-
ups and 52 hrs of
operation
(both anode fuel
and air humidified
in-situ, anode side
blocked-out)

| | Current |
|---|---|
| | density |
| Voltage | (mA/cm2) |
| 0.56 | 180 |
| 0.75 | 45 |
| 0.8 | 22.4 |
| 0.81 | 15.2 |
| 0.84 | 8 |
| 0.87 | 1.7 |
| 0.87 | 0.8 |
| 0.88 | 0.4 |
| 0.88 | 0 |

### Example 7

A new fuel cell was constructed such that the syringe was drilled in a similar manner to the fuel cell in example 5. In this case a 60 cc syringe was used to enclose the fuel cell as the cathode tubular containment structure and the air was humidified using an inline passive humidifier. The internal shape of this tubular containment structure was changed such that the flow path has the shape of a truncated cone with the wide end at the air inlet and the narrow end of the air exit. This structure helps keep the pressure more constant over the fuel cell active area in the tubular containment structure and thus the reactant concentration essentially constant. The 60 cc syringe was fitted such that the hydrogen inlet tube having an in line humidifier penetrated the 60 cc syringe and was connected to the 10 cc syringe hydrogen reservoir. During the operation the hydrogen flow control was used to stop flow from the reservoir to the environment. The current and voltage response were measured at room temperature. The voltage was found to be 0.55 and the current density was maintained at 164 mA/cm. The cell was heated and controlled at a temperature of 65° C. The voltage was measured at 0.59 volts the current density was 181 mA/cm. In another run at room temperature the fuel cell had the following voltage-current characteristics:

| Voltage (V) | Current (A) |
|---|---|
| 0.54 | 1.575 |
| 0.73 | 0.419 |
| 0.78 | 0.211 |
| 0.8 | 0.138 |
| 0.82 | 0.08 |
| 0.87 | 0.016 |
| 0.878 | 0.008 |
| 0.88 | 0.004 |
| 0.9 | 0 |

### Example 8

### Flat Tubular Fuel Cell

A new fuel cell was constructed such that the anode side of the membrane electrode assemble was contacted with a conventional graphite plate with conventional channels and the cathode was contacted with a copper wire screen, cathode gas disperser and electron conductor and external electrode. A clear plastic panel with about 0.125 inch spacer was mounted in order to create the tubular containment structure over the cathode assembly. This cell was run at room temperature the fuel cell had the following voltage-current characteristics:

Voltage and current characteristics of a Single Flat Fuel Cell
with tubular containment structure Cathode using a 10 sq cm
Fuel Cell Store MEA.

| Voltage (V) | Current (A) |
|---|---|
| .87 | .012 |
| .76 | .24 |
| .66 | .70 |
| .56 | 1.4 |
| .46 | 2.26 |
| .405 | 2.7 |
| .308 | 3.3 |

### Example 9

### No Carbon Cloth Cylindrical Tubular Cell

A new MEA was constructed so that the anode side of the MEA had the gas disperser, electron collector and external electrode imbedded in the catalyst layer. The Cathode side had a conventional carbon cloth between the catalyst layer and the gas disperser and electron collector and external electrode assembly. The fuel cell was constructed using the same techniques found in Examples 3 or 4. This cell was run at room temperature the fuel cell had the following voltage-current characteristics:

| Voltage (V) | Current (A) |
|---|---|
| 0.865 | 0.007 |
| 0.74 | 0.74 |
| 0.68 | 1.31 |
| 0.605 | 2.24 |
| 0.583 | 2.48 |
| 0.545 | 3 |
| 0.508 | 3.57 |
| 0.448 | 4.4 |
| 0.408 | 4.96 |

### Example 10

In this example we compare the voltage current characteristics for a conventional Single Flat fuel cell with graphite bipolar plates with one of our tubular designed fuel cells. The conventional cell weighs 2680 grams and the tubular cell built in a similar manner found in example 4 that weighed 70 grams. Both cells used the same 50 sq. cm. MEA. Both were operated at room temperature and atmospheric pressure. The conventional cell was fed humidified gases from a commercial fuel cell station. The Experimental Tubular cell was fed the same gases but also had liquid water sprayed on the gas disperser and electron collector and external electrode assembly to evaluate if liquid water adversely affected the performance. No degradation was observed. In fact at most voltages the current for the tubular cell was slightly higher than the conventional cell, see tables below:

Single Flat Cell Conventional Fuel Cell sold by Electrochem;
using a 50 sq cm E-Tek (BASF FUEL CELL) inc. MEA;
operated at atmospheric Pressure and Room Temperature.
Cell weight 2680 gm; 0.027 W/kg-cm²

| Voltage (V) | Current (A) |
|---|---|
| 961 | .001 |
| .821 | .1.01 |
| .75 | 2.01 |
| .628 | 4.11 |
| .518 | 6.2 |
| .44 | 8.6 |
| .3 | 12. |

Single Experimental Tubular Cell; using 50 sq cm E-Tek
(BASF FUEL CELL) inc. MEA; Operated at atmospheric
Pressure and Room Temperature. Cell weight 70 g; 1.2 W/kg-cm²

| Voltage (V) | Current (A) |
|---|---|
| .91 | .002 |
| .826 | .1.11 |
| .76 | 2.0 |
| .618 | 4.2 |
| .524 | 6.1 |
| .44 | 8.8 |
| .3 | 12.5 |

### Example 11

The construction and operation of a passively, internally humidified flat tubular fuel cell with a single 50 sq cm MEA is described in this example. The copper wire about 40% open screen, cathode and anode gas disperser and electron conductor are soldered to brass a structure, the external electrode, that outlines the square copper screen. These brass structures are inset into a 0.250 in thick plastic rectangle with solid sides of about 0.50 inch wide and with an open area about 7 cm. on a side. The bottom of this plastic structure has a reservoir for the water used in internal humidification of the reactants, hydrogen and air. The cell was constructed such that the screens are facing the MEA thus leaving an open tubular channel of about 2.5 inch. wide and 0.250 inch deep. This effectively eliminates any water bridging near the MEA surface. The cell was operated at room temperature and atmospheric pressure with internal passive humidification of the reactant gasses. The voltage current characteristics are seen below. We feel that the lower current at a particular voltage was due to non optimal contact at the MEA current collector surface.

Flat Tubular Cell Experimental Cell; using a 50 sq cm E-Tek
(BASF FUEL CELL) inc. MEA; Operated at atmospheric
Pressure and Room Temperature. Cell weight 208 gm

| Voltage (V) | Current (A) |
|---|---|
| .962 | .001 |
| .827 | .425 |
| .710 | 1.224 |
| .61 | 2.227 |
| .508 | 3.425 |
| .44 | 4.228 |
| .307 | 5.73 |

### Example 12

In this example we compare the power density as function of weight for what is generally considered today to be the best performing single 10 cm. sq. MEA fuel cell, the triple serpentine cell made by Fuel Cell Technology, with our tubular fuel cell constructed as described in examples 3 and 4. In many applications it is strongly desirable to have very high power to weight ratio as desired by the current wearable power competition being carried out by the DOD. In this example we compare the specific power produced by the “best” conventional 10 sq; cm. cell and our tubular cell. Both were operated at room temperature using air as the cathode reactant and hydrogen as the anode reactant. Humidification was the same for both cells. Each cell using an electronic controller that allows the fuel cell voltage to be specifically set so comparisons can be essentially exact as a function of voltage. We observe that the power density for the tubular cell with its better water handling characteristics and its simple design, constructed as described in examples 3 and 4, was about 70 time the best conventional cell. See below:

Flat Conventional Cell, Fuel Cell Technology, 10 sq cm E-Tek
(BASF FUEL CELL) inc. MEA; Atmospheric Pressure air at
Room Temperature. Weight 2000 grams; at about 0.481 volts
producing 0.22 W/kg-cm²

| Voltage (V) | Current (A) |
|---|---|
| .95 | .008 |
| .97 | .825 |
| .713 | 2.54 |
| .664 | 4.07 |
| .602 | 6.09 |
| .481 | 9.12 |
| .421 | 10.13 |

Tubular Cell; 10 sq cm E-Tek (BASF FUEL CELL) inc. MEA;
Atmospheric Pressure air at Room Temperature. Weight 25
grams; at about 0.481 volts producing 15.59 W/kg-cm²

| Voltage (V) | Current (A) |
|---|---|
| .95 | .005 |
| .97 | .835 |
| .713 | 2.74 |
| .664 | 3.97 |
| .602 | 5.59 |
| .481 | 8.12 |
| .421 | 8.7 |

### Example 13

In this example two element stacks were constructed using two cylindrical tubular and the two flat tubular elements described in examples 12 and 11 respectively. Thus in each case the stack had two anodes and two cathodes connected in series. Each anode and cathode were fed the appropriate reactants using a tubular constructed internal low pressure drop gas reservoirs that essentially eliminates the droplet water formation and flow restriction of conventional graphite plate serpentine reactant chambers. This provides a process for increasing the voltage for a given membrane surface area while essentially maintaining the current producing capacity of the system. In this case the open circuit voltage was 1.78 volts, about twice the voltage of a single cell and the voltage at each current load was about twice the voltage for a single cell.

It will be appreciated that the above description is related to the invention by way of the example only. Many variations on the invention will be obvious to those skilled in the art and such obvious variations are within the scope of the invention as described herein whether or not expressly described.

What is claimed:

1. A tubular fuel cell comprising:
an internal low pressure drop anode gas reservoir;
a combined external electrode, gas diffusion and electron collector for the anode;
a catalyst containing anode;
a proton conductor;
a catalyst containing cathode;
a combined external electrode, gas diffusion device and electron source for the cathode; and
an internal low pressure drop cathode gas reservoir.

2. A proton membrane tubular fuel cell comprising:
an element that provides an anode reactant;
an element that is an in line anode reactant humidifier;
an element that is an integrated liquid water shedding, essentially constant fuel pressure containment tubular structure;
an element that is a combined external electrode, gas diffusion device, and an electron collector for the anode;
an element that is a catalyst containing anode;
an element that is a proton conductor;
an element that is a catalyst containing cathode;
an element that is a combined, external electrode, gas diffusion device and electron source for the cathode;
an element that is an integrated liquid water shedding, essentially constant fuel pressure containment tubular structure;
an element that is an in line cathode reactant humidifier;
an element that provides an cathode reactant.

3. The fuel cell of claim 2 wherein the cathode tubular essentially constant pressure reactant containment structures have dimensions such that formed liquid water droplets are removed by gravity and will not substantially inhibit the flow of anode and cathode reactants.

4. The fuel cell of claim 3 wherein the gas diffusion device and electron collector and the gas diffusion device and electron source are high current conduction structures with open area between 10 and 90 percent.

5. The fuel cell of claim 4 wherein the gas diffusion device and electron collector and the gas diffusion device and electron source are metal screen made of stainless steel, platinum alloys, gold alloys, silver, nickel, or copper with open area between 10 and 90 percent.

6. The fuel cell of claim 5 wherein the catalyst containing anode and catalyst containing cathode are structured platinum loaded carbon black with a proton conductor creating a triple interface.

7. The fuel cell of claim 6 wherein the tubular essentially constant pressure reactant containment structures are rectangular and have a minimum dimension of 0.10 inch normal to the catalyst layer and second dimension normal to the first dimension and more or less parallel to the catalyst layer of 0.5 inch.

8. The fuel cell of claim 6 wherein the cathode tubular essentially constant pressure reactant containment structures are cylindrical and have a minimum radial dimension of 0.2 inch normal to the catalyst layer.

9. The fuel cell of claim 7 wherein the anode reactant is hydrogen or methanol.

10. The fuel cell of claim 9 wherein the in line cathode and anode reactant humidifiers are integrated into the tubular essentially constant pressure reactant containment structures to passively humidify the reactants.

11. The fuel cell of claim 8 where the anode reactant is hydrogen or methanol.

12. The fuel cell of claim 11 where the in line cathode and anode reactant humidifiers are integrated into the tubular essentially constant pressure reactant containment structures to passively humidify the reactants.

13. A fuel cell for constructing tubular fuel cell comprising:
an element that is used to monitor the fuel cell temperature;
an element that is used to control the fuel cell temperature;
an element that is an in line passive anode gas humidifier;
an element that is an integrated liquid water shedding, essentially constant fuel pressure containment tubular structure;
an element that is a combined external electrode, gas diffusion device and electron collector for the anode;
an element that is a catalyst containing anode;
an element that is a proton conductor;
an element that is a catalyst containing cathode;
an element that is a combined external electrode, gas diffusion device and electron source for the cathode;
an element that is an in line passive cathode gas humidifier;
an element that is an integrated liquid water shedding, essentially constant fuel pressure containment tubular structure.

14. The fuel cell of claim 13 wherein the catalyst containing anode and catalyst containing cathode are structured platinum loaded carbon black with a proton conductor creating a triple interface.

15. The fuel cell of claim 14 wherein the cathode and anode tubular essentially constant pressure reactant containment structures are rectangular, elliptical or cylindrical with a minimum tubular dimension of 0.125 inch.

16. The fuel cell of claim 15 wherein the gas diffusion device and electron collector and the gas diffusion device and electron source are metal screen made of stainless steel, platinum alloys, gold alloys, silver, nickel, or copper with open area between 10 and 90 percent.

17. The fuel cell of claim 16 wherein the temperature control is the result of thermal fluid flow across the control surfaces or water spray into the tubular essentially constant pressure reactant containment structures.

18. A tubular fuel cell system comprising:
a source of anode reactant;
a source of cathode reactant;
anode reactant humidifiers;
anode and cathode reactant tubular reactant containment structures;
catalyst containing anodes;
proton conductors;
catalyst containing cathodes;
devices acting as external electrode, combined gas diffusion device and electron transfer device for the cathode and anode;
cathode reactant humidifiers;
devices to control the pressure and reactant flow through the tubular structures;
a temperature monitoring system;
a temperature control system; and
integrated current and voltage monitors for each cell.
